(19) United States
(12) Patent Application Publication
(10) Pub. No.: US 2008/0317274 A1
(43) Pub. Date: Dec. 25, 2008

(54) Apparatus for Necklace Type Radio Headset

(75) Inventor: Hyoung Ho Kim, Seoul (KR)

Correspondence Address: H.C. PARK & ASSOCIATES, PLC, 8500 LEESBURG PIKE, SUITE 7500, VIENNA, VA, 22182, US

(73) Assignee: UBIXON CO., LTD., Seoul (KR)

(21) Appl. No.: 11/574,348

(22) PCT Filed: May 13, 2006
(86) PCT No.: PCT/KR06/01796

§ 371 Date: Feb. 27, 2007

(30) Foreign Application Priority Data
Jan. 11, 2006 (KR) 10-2006-0003279

(51) Int. Cl. H04R 25/00

(52) U.S. Cl. 381/370

(57) ABSTRACT

Disclosed is a necklace type radio headset capable of overcoming problems of conventional headsets, in which cables connected between earphones of a headset easily get tangled with each other or with other objects in a storing place of the headset while the headset is not used. The headset according to the present invention includes casings connected via a cable and enclosing one or more Bluetooth modules and respective speakers therein, and the casings are detachably coupled to each other by a coupling means, so that a user can wear the headset around his or her neck like a necklace because the cable always maintains a ring shape. As the coupling means, one of the casings has a depression for receiving a speaker housing to be inserted into a user's ear, and the speaker housing is input in the depression while it is not used. Further, since either or both of the casings have respective permanent magnets, the casings are coupled by attractive magnetic force exerted between the permanent magnets. According to the present invention, cables of a headset do not easily get tangled with each other or do not easily get tangled with other objects. Further, since a user can carry the headset by putting the headset around his or her neck, the headset cannot easily be lost.

### TECHNICAL FIELD

The present invention relates to a necklace type radio headset, and more particularly to a necklace type radio headset capable of solving problems with conventional headsets having a “V” shape, the problems in which they are difficult to store and carry when they are not used and not inserted into user's ears, although they do not have a problem when they are used, so that the headset according to the present invention includes a pair of earphones connected via a cable and detachably attached to each other by using a coupling means, whereby the headset can be carried as it is put around a user's neck like a necklace.

### BACKGROUND ART

An earphone means an earphone receiver and is an apparatus for transferring sound from audio sources such as a mobile phone, a car phone, a record player, a cassette player, a compact-disk (CD) player, or a compact radio to a speaker, so that a user can listen to the sound from the audio sources using the speaker. Among earphone receivers, a crystal receiver is structured to vibrate a vibration plate using the piezo effect of a crystal device, and a magnetic receiver is structured to vibrate a vibration plate using current flowing through a coil. When using such earphones, a user inserts earphone receivers in his or her ears, or puts earphone receivers close over his or her ears wearing a headband on a user's head. The earphone in which earphone receivers are worn on a user's head when they are used are called headphones.

There are a variety of types of earphones which have different vibration films, vibration plates and sizes of magnets, but are operated in the same manner such that when current flows through a magnet, an attractive force and a repulsive force exerted between the permanent magnet and the electromagnet vary according to the intensity of current and phase and a vibration film vibrates according to the attractive force and the repulsive force, so that audible sound is generated based on the vibrations of the film.

As described above, the operational principles of earphones and headphones are almost the same. However, the headphones and the earphones differ in the method of wearing them. That is, a user puts on the headphone on his or her head such that speakers of the headphone are placed in close proximity to his or her ears, but a user merely directly inserts speakers of the earphone into his or her respective ears. Further, among headphones, a headphone in which a receiver and a microphone are integrated into a single set is called a headset. The headphones or the headsets are classified into a single earpiece type and a double earpiece type, and the double earpiece type headsets are further classified into a stereo type and a monaural type.

On the other hand, in order to basically reduce traffic accidents caused by the use of cellular phones while driving, drivers are totally banned from speaking on a wireless phone while driving under the regulation. Accordingly, new products that can be used without being in conflict with the laws and regulations have been produced. One example thereof is a hands-free kit. A driver can use a phone while driving by using the hands-free kit in a manner such that the driver mounts his or her phone on the hands-free kit, and sound from the driver's phone is output from a speaker of the hands-free kit or a speaker of the car. Accordingly, a driver can speak into a phone without holding up a cellular phone with a hand. Since the hands-free kit is used in conjunction with a built-in speaker of a car, too much noise or echoing are caused when a user is on a phone while driving a car, so that messages on a phone will not be clearly received and a driver's privacy can be invaded when other riders are in the car. Accordingly, an over-the-ear type headset and a wireless earphone headset have been sold in order to overcome the disadvantage of the hands-free kit, so that communication message on the phone do not leak while a user is on a phone and there is little echo if the driver uses the headset earphone by inputting earphone receivers into the driver's ears or putting them around user's ears.

As described above, general earphones are divided into wired phones and wireless phones. The wired phone is configured in a manner such that it is connected to an earphone jack of a terminal of an audio source such as a cassette player or a compact disk (CD) player via wires in a cable, thereby receiving an electrical signal transmitted through wires from the terminal of the audio source, converting the electrical signal into an audible signal, and outputting the audible signal. The wireless earphone further comprises a wireless signal receiver receiving a signal transmitted from a wireless terminal such as a cellular phone, a personal digital assistant (PDA) or a notebook computer through wireless communication channels, thereby receiving a voice signal or a control signal.

Recently, as communication between individuals using portable terminals becomes popular, people are provided with a variety of information communication services such as wireless communication, value-added services, or short message service (SMS). Further, since a communication method using a Bluetooth module is applied to earphones or wireless terminals, a user can communicate with other people from a distance without manually holding up a portable terminal.

The Bluetooth module embedded wireless earphone comprises a Bluetooth chip, a battery pack, a speaker, a microphone, a receiving button, and a wearing ring in a single casing. When wearing the earphone, a user first pulls the wearing rings some distance from the casing away, and then wraps the wearing rings around respective outer ears. In the case of monaural earphone with a single speaker, the wearing ring is hung from one outer ear of a user. However, in the case of stereo earphones or monaural earphones with double speakers, a pair of ear-pieces is connected via wires in a cable. Generally, one of the ear-pieces embeds a speaker and an antenna therein, and the other of the ear pieces embeds a speaker and a battery pack therein.

In the case of the wired earphone, there is no problem when the earphone is used in a state of being inserted in user's ears. However, there is a problem with the wired earphone when the earphone is not used because it is generally carried and stored in a user's pocket or other place. That is, the cable between ear pieces of the wired earphone is twisted or gets tangled with other objects in the storing place while the earphone is stored. Accordingly, it is very inconvenient to use the wired earphone in crowded subways or buses because a user has to untangle the tangled cable of the earphone.

Further, since the earphone is too small, it can be easily lost, and it is difficult to find after a user stores or misplaces the earphone. Accordingly, the earphone is very inconvenient to use.

### DISCLOSURE OF INVENTION

### Technical Problem

Accordingly, the present invention has been devised in consideration of the afore-mentioned problems and situations, and it is an object of the present invention to provide a necklace type headset capable of preventing a cable between earphones of a headset from getting tangled while the headset is not used.

It is a further object of the present invention to provide a necklace type headset in which a cable is not easily tangled and which can be easily found in a storage place when the headset is not used.

It is a still further object of the present invention to provide a necklace type headset having a good appearance, so that it can be used as an accessory while the headset is not used.

It is a yet further object of the present invention to provide a necklace type headset in which a user can easily and quickly find the headset in a storage place and insert ear phones thereof into respective ears to listen to music or to speak on the phone.

### Technical Solution

In order to achieve the above objects and advantages, according to one aspect of the present invention, there is provided a necklace type headset for stereo listening, having a pair of casings enclosing one or more Bluetooth modules which receive electric signals transmitted from an external electronic device, and enclosing respective speakers therein, the casings connected to each other via a cable, wherein speaker housings which are provided to be inserted into respective ears of a user and enclose respective speakers therein are installed to respective first sides of the casings, whereby protruding from outer surfaces of the first sides of the casings, and wherein speaker housing receiving depressions are formed on respective casings to which the speaker housings are provided, so that the respective speaker housings are received in the depressions, respectively, by being pressed.

According to a further aspect of the present invention, there is provided a necklace type radio headset for stereo listening, having a pair of casings enclosing respective speakers and enclosing one or more Bluetooth modules which receive electric signals transmitted from an external electronic device, the casing connected to each other via a cable, wherein speaker housings which are provided to be inserted into respective ears of a user and enclose the speakers are installed to outer surfaces of respective sides of the casings so as to be protruded from the outer surfaces of the casings, and wherein permanent magnets having different poles are installed inside respective casing on respective second sides of the casings, the second sides not having the speaker housings thereon, so that the casings are attached to each other and detached from each other by magnetic force exerted between the permanent magnets.

The permanent magnets may be installed outside the casings.

According to a still further aspect of the present invention, there is provided a necklace type radio headset for stereo listening, having a pair of casings enclosing respective speakers therein and enclosing one or more Bluetooth modules for receiving electric signals transmitted from an external electronic device, the casings connected to each other via a cable, wherein speaker housings which are provided to be inserted into respective ears of a user and enclose respective speakers are installed outside the casings to protrude from outer surfaces of respective first sides of respective casings, and wherein a permanent magnet is provided on a second side of the casing, the second side not having the speaker housings thereon, and an iron piece is provided on the other casing, so that the casings are attached to each other and detached from each other by magnetic force between the permanent magnet and the iron piece.

According to a yet further aspect of the present invention, there is provided a necklace type radio headset for stereo listening, having a pair of casings enclosing respective speakers therein and enclosing one or more Bluetooth modules for receiving electric signals transmitted from an external electronic device, the casings connected to each other via a cable, wherein speaker housings which are provided to be inserted into respective ear holes of a user and enclose respective speakers are installed on the casings to protrude from outer surfaces of respective first sides of respective casings, and wherein permanent magnets are provided on respective first sides of the casings, the first sides having respective speaker housings installed thereon, in which the speaker housings are arranged on the casings in an eccentric manner.

According to a yet still further aspect of the present invention, there is provided a necklace type radio headset, having a casing in which a speaker outputting audible sound and a Bluetooth module receiving electrical signals transmitted from an external electronic device are enclosed therein, wherein the casing is provided with a speaker housing enclosing the speaker at a first side, a speaker housing having a speaker therein is connected to the casing, the casing has a depression for receiving the earphone casing therein on a second side thereof, the second side not having the speaker housing installed thereon, and the earphone casing is inserted into the depression by being pressed.

The depression may be provided on a surface of the casing, on which the speaker housing is provided.

According to a yet further aspect of the present invention, there is provided a necklace type radio headset for stereo listening, having a pair of casings connected to each other via a cable, enclosing one or more Bluetooth modules for receiving electric signals transmitted from an external electronic device, and enclosing respective speakers therein, wherein speaker covers encasing respective speakers are installed on outer surfaces of respective first sides of the casings, ear loops are provided on respective second sides of the casings so as to be worn around respective outer ears of a user, and iron pieces are provided on outer surfaces of the casings, the iron pieces attracting permanent magnets in the speakers.

Respective casings may have respective receiving parts on respective second sides of the casings, which are outer sides of the casings, for receiving the speaker covers thereon and enclosing iron pieces therein.

Respective steps may exist between respective speaker covers and respective receiving parts.

According to a yet further aspect of the present invention, there is provided a necklace type radio headset for stereo listening, having a pair of casings enclosing one or more Bluetooth modules which receive electrical signals transmitted from an external electronic device, and enclosing respective speakers therein, the casings being connected via a cable, wherein the casing has a coupling projection at a side thereof, and the other casing has a coupling depression having a shape corresponding to that of the coupling projection, so that the coupling projection is forcedly inserted into the coupling depression by being pressed.

Speaker housings enclosing the speakers respectively, may be provided to be inserted into ears of a user, and may be installed to protrude from outer surfaces of respective outward sides of the casings, wherein the coupling projection and the coupling depression are formed on surfaces of respective sides of the casings.

According to a yet further aspect of the present invention, there is provided a necklace type radio headset for stereo listening, having a pair of casings enclosing one or more Bluetooth modules which receive electrical signals transmitted from an external electronic device, and enclosing respective speakers therein, the casings being connected via a cable, wherein the casing may have a sliding projection at a side thereof, and the other casing has a sliding depression having a shape corresponding to that of the sliding projection, so that the sliding projection slides into the sliding depression and the sliding projection is selectively fixed.

The electronic device may be a mobile wireless phone which converts high frequency signals received via an antenna into radio frequency data using a Bluetooth module of the electronic device and transmits the data to a Bluetooth module of the headset.

At least one of the casings may enclose a microphone therein.

The necklace type radio headset according to the present invention has an advantage in which cables of a headset do not get tangled with each other or with other objects and the headset may not easily be lost because it is worn around a user's neck.

### Advantageous Effects

The necklace type headset according to the present invention has the following advantages.

First, it gives convenience to a user because a cable worn around a user's neck and connected between ear-pieces maintains its shape to look like a necklace and does not get tangled or twisted.

Second, since a user can wear a necklace type headset around his or her neck like a necklace, the cable between earphones of the headset does not get tangled with other objects and there is little risk of the headset getting lost.

Third, since the headset has a good appearance and has a ring shape overall, the headset can be worn like an accessory.

Fourth, it is convenient to use the headset because a user can easily detach ear-pieces from the casing of the headset while wearing it around his or her neck and insert the ear-pieces into his or her ears to listen to music or voice over the phone.

### BRIEF DESCRIPTION OF THE DRAWINGS

FIG. 1 through FIG. 5 are a perspective view, an exploded perspective view, a front view, a side view and a plan view illustrating a necklace type radio headset according to a first embodiment of the present invention.

FIG. 6 through FIG. 10 are a perspective view, an exploded perspective view, a front view, a side view and a plan view illustrating a necklace type radio headset according to a second embodiment of the present invention.

FIG. 11 through FIG. 15 are a perspective view, an exploded perspective view, a front view, a side view and a plan view illustrating a necklace type radio headset according to a third embodiment of the present invention.

FIG. 16 through FIG. 20 are a perspective view, an exploded perspective view, a front view, a side view and a plan view illustrating a necklace type radio headset according to a fourth embodiment of the present invention.

FIG. 21 through FIG. 25 are a perspective view, an exploded perspective view, a front view, a side view and a plan view illustrating a necklace type radio headset according to a fifth embodiment of the present invention.

FIG. 26 through FIG. 30 are a perspective view, an exploded perspective view, a front view, a side view and a plan view illustrating a necklace type radio headset according to a sixth embodiment of the present invention.

FIG. 31 through FIG. 35 are a perspective view, an exploded perspective view, a front view, a side view and a plan view illustrating a necklace type radio headset according to a seventh embodiment of the present invention.

FIG. 36 through FIG. 40 are a perspective view, an exploded perspective view, a front view, a side view and a plan view illustrating a necklace type radio headset according to an eighth embodiment of the present invention.

FIG. 41 through FIG. 45 are a perspective view, an exploded perspective view, a front view, a side view and a plan view illustrating a necklace type radio headset according to a ninth embodiment of the present invention.

### BRIEF DESCRIPTION OF KEY ELEMENTS IN THE DRAWINGS

100: radio headset

110,112: casing

120, 122: speaker housing

130, 132: depression

150: cable

### BEST MODE FOR CARRYING OUT THE INVENTION

Hereinafter, a necklace type radio headset according to the present invention will be described with reference to the accompanying drawings.

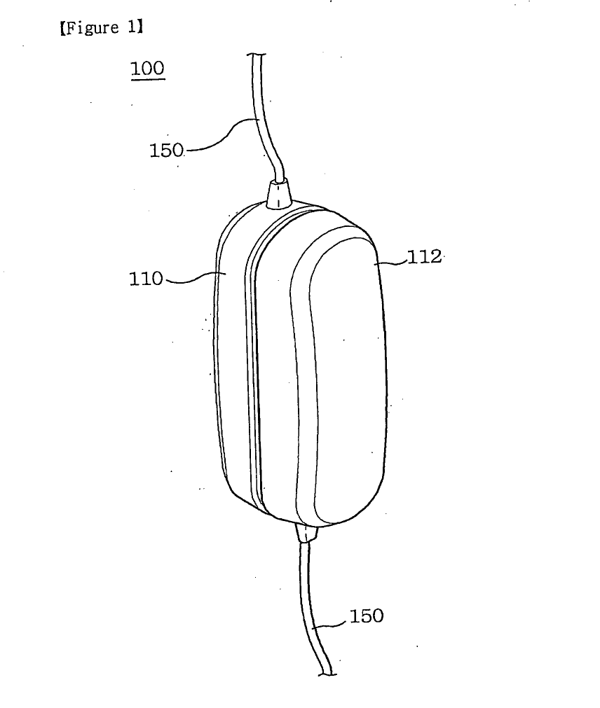

As shown in FIG. 1, the necklace type radio headset comprises an electronic device (not shown) having a Bluetooth module and a radio headset 100 having a Bluetooth module receiving electrical signals from the electronic device. The electronic device is a mobile wireless phone which converts high frequency signals received via an antenna into wireless data using a Bluetooth module of the electronic device and then transmits the wireless data to a Bluetooth module of the headset 100, or a device capable of transmitting voice signals or control signals on wireless communication channels, such as a PDA or a computer.

The headset 100 can include “in-the-ear” type earphones inserted into a user's respective ears or “over-the-ear” type earphones worn on a user's head. The headset 100 comprises earphones serving as receivers and a microphone serving as a transmitter. The headset 100 can be for monaural or stereo listening. In embodiments described below, the “in-the-ear” type earphones are used as examples but the earphones in the headset according to the present invention are not limited thereto.

### FIRST EMBODIMENT

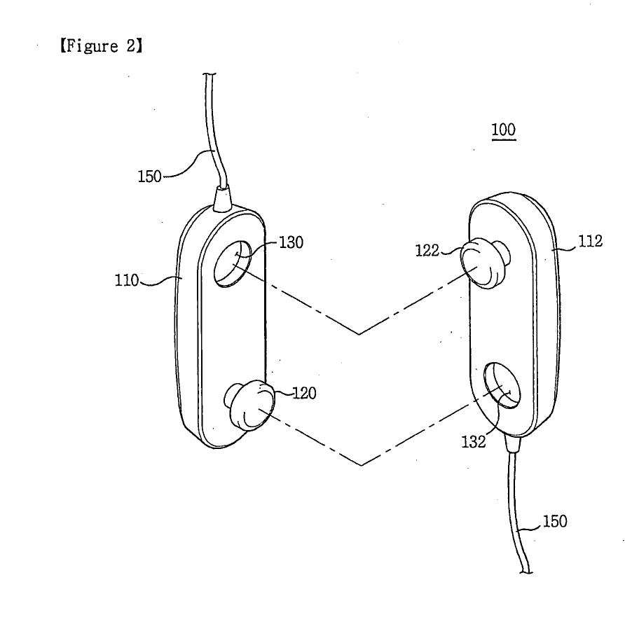

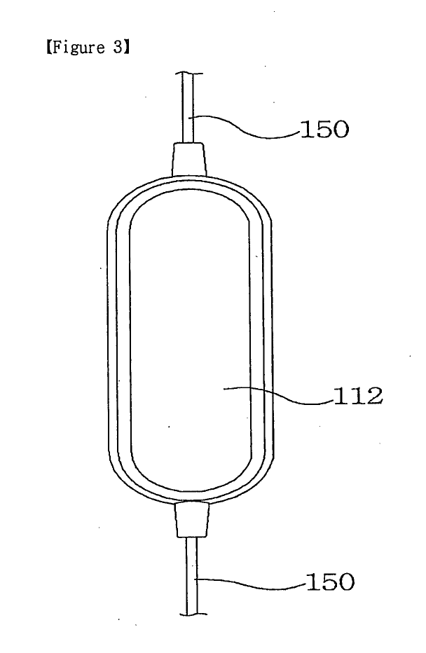

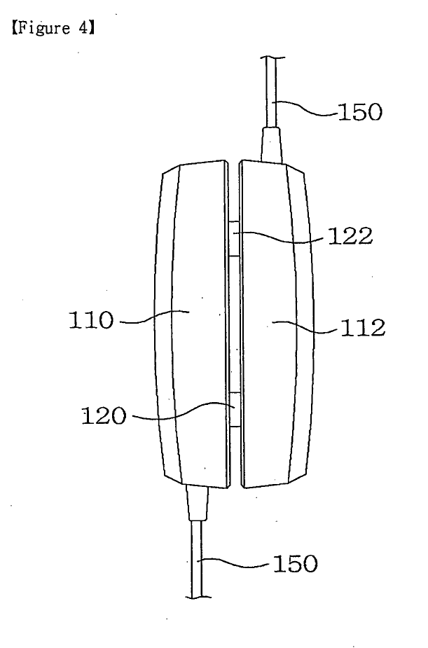

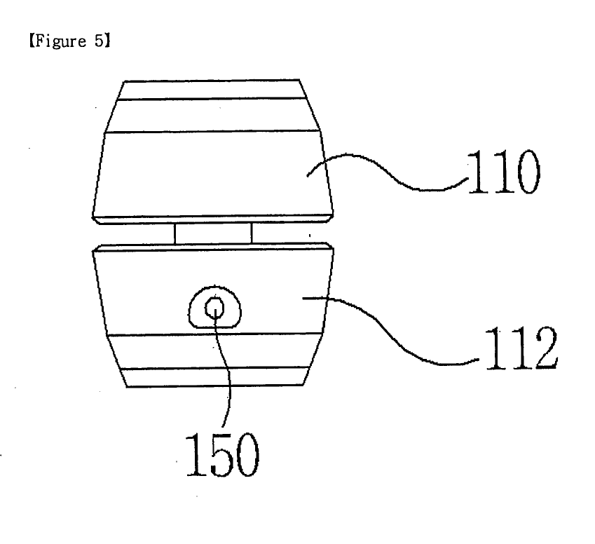

Referring to FIG. 1 through FIG. 5, the headset 100 according to a first embodiment of the present invention comprises a pair of casings 110 and 112, in which a Bluetooth module is enclosed in either the casing 110 or the casing 112, and speakers are enclosed in respective casings 110 and 112. Further, the casings 110 and 112 have respective structures corresponding to each other. On respective first sides of the casings 110 and 112, respective speaker housings 120 and 122 are installed to protrude from the surfaces of the sides of the casings 110 and 112.

The casings 110 and 112 further have respective depressions 130 and 132 for receiving respective speaker housings 120 and 122 therein. That is, the casing 110 has the depression 130 for receiving the speaker housing 122 installed to a first side of the casing 112 on a first side thereof and the casing 112 has the depression 132 for receiving the speaker housing 120 installed to the first side of the casing 110 on the first side thereof, the first sides of the casings 110 and 112 facing each other. Accordingly, the speaker housings 120 and 122 are received in respective depressions 132 and 130 by pressing the casings 110 and 112 against each other.

The casings 110 and 112 are connected via a cable 150 enclosing wires therein. Inside either the casing 110 or the casing 112, or inside both of the casings 110 and 112, a battery pack, a microphone and/or a receiving button are provided.

Accordingly, when the speaker housing 120 installed on the casing 110 is forced to be received into the depression 132 of the other casing 112 by pressing the casings 110 and 112 against each other, the cable 150 forms a ring shape, so that a user can wear the cable having a ring shape around his or her neck like a necklace. That is, since a user can wear the headset 100 around his or her neck, the headset 100 cannot be easily lost, and can give a good appearance to the user.

### SECOND EMBODIMENT

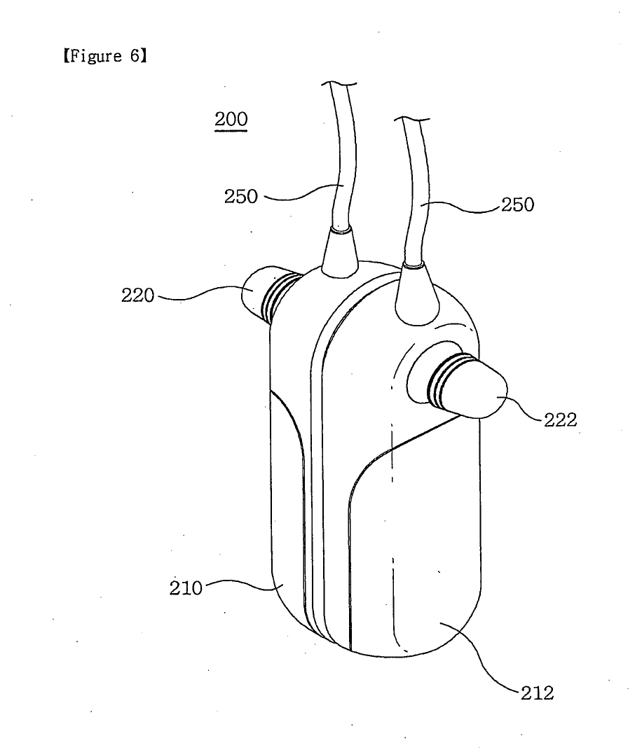

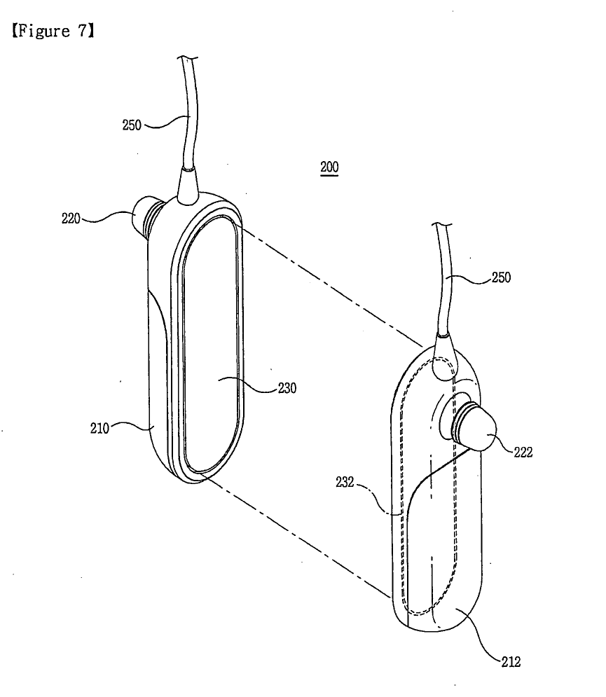

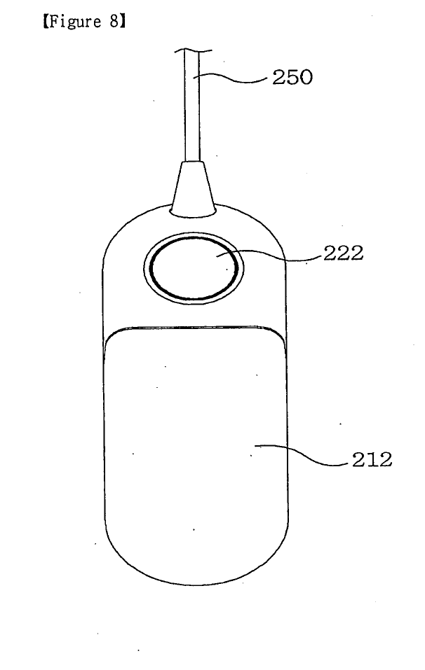

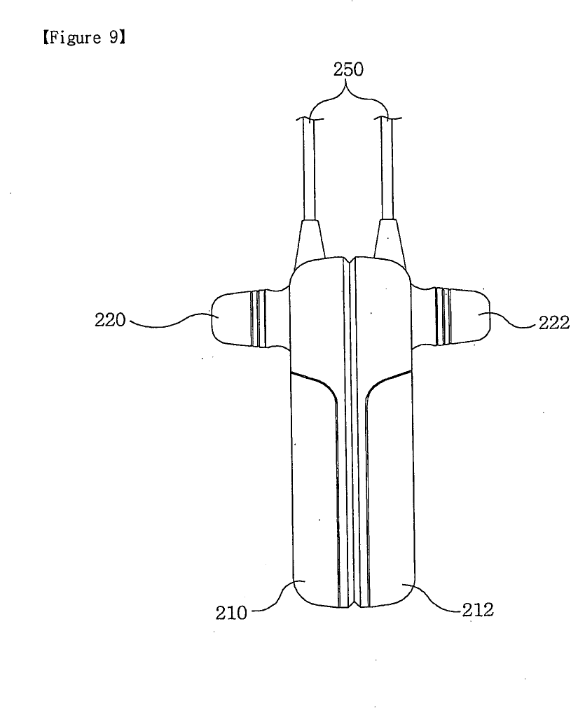

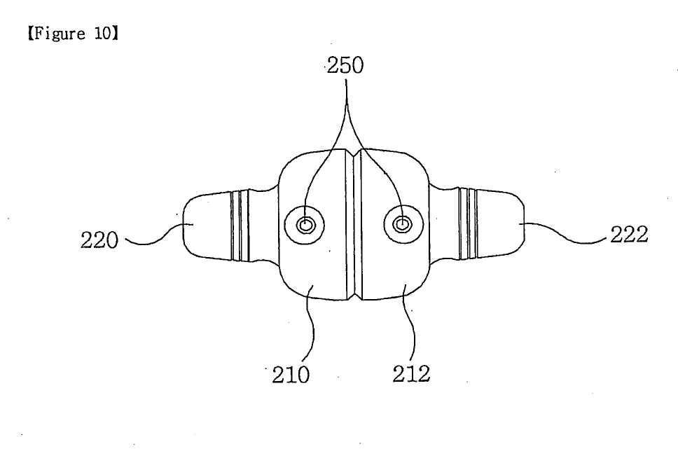

Referring to FIG. 6 through FIG. 10, a headset 200 according to a second embodiment of the present invention comprises a pair of casings 210 and 212, in which a Bluetooth module is enclosed in either the casing 210 or the casing 212, and speakers are enclosed in respective casings 210 and 212. Further, the casings 210 and 212 have respective structures corresponding to each other. On the outer surfaces of respective first sides of the casings 110 and 112, respective speaker housings 120 and 122 to be inserted into ears of a user are installed to protrude from the outer surfaces.

On respective second sides of the casings 210 and 212, the second sides not having the speaker housings 220 and 222 installed thereon, permanent magnets 230 having different poles are installed to be exposed outside the casings 210 and 212 or to be embedded inside the casings 210 and 212. Accordingly, the casings 210 and 212 can be attached to or detached from each other using magnetic force of the permanent magnets 230.

Alternatively, the casings 210 and 212 may be coupled in a manner such that a permanent magnet 230 is provided to either the casing 210 or the casing 212, and an iron piece (not shown) is provided to the other casing 210 or 212.

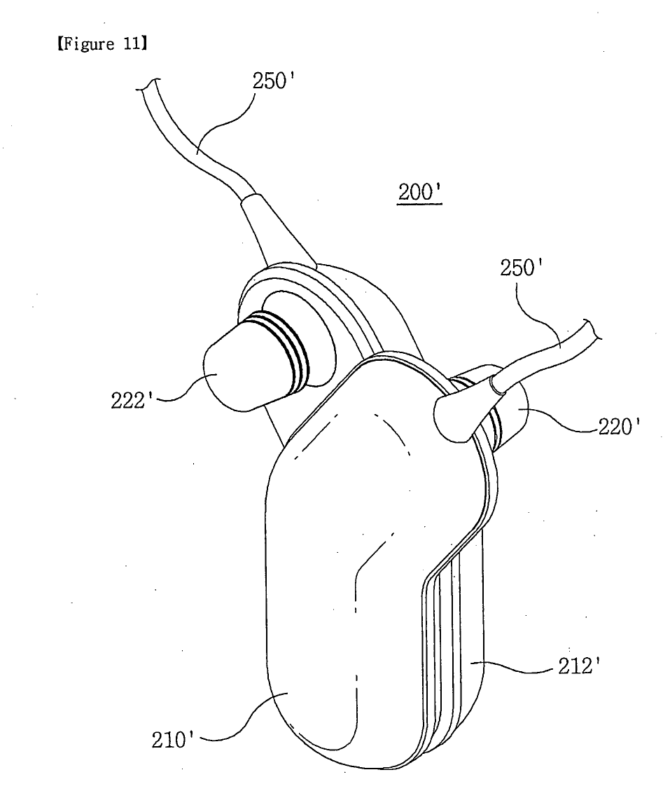

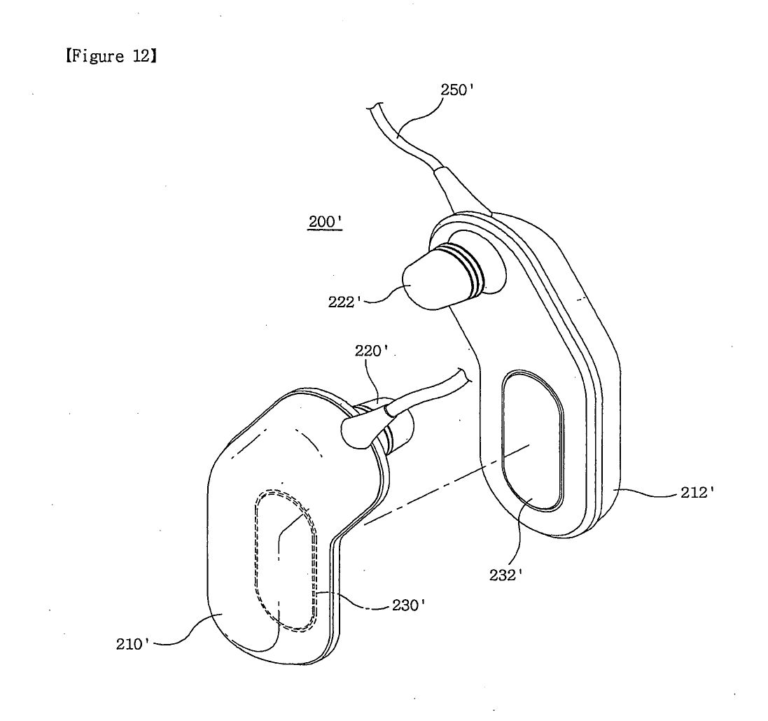

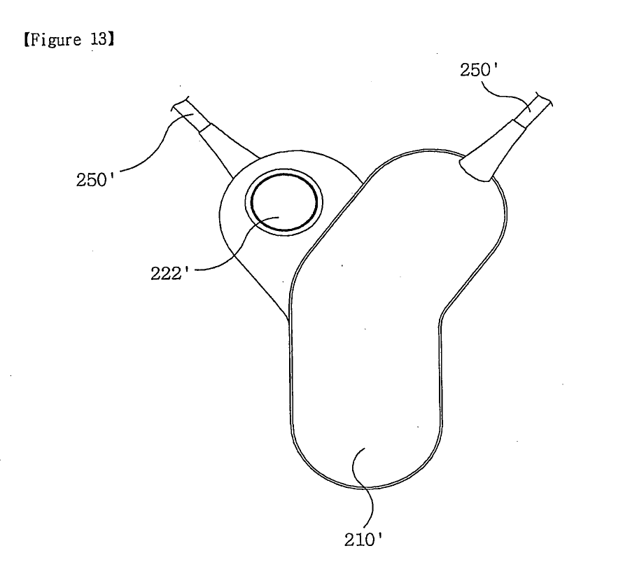

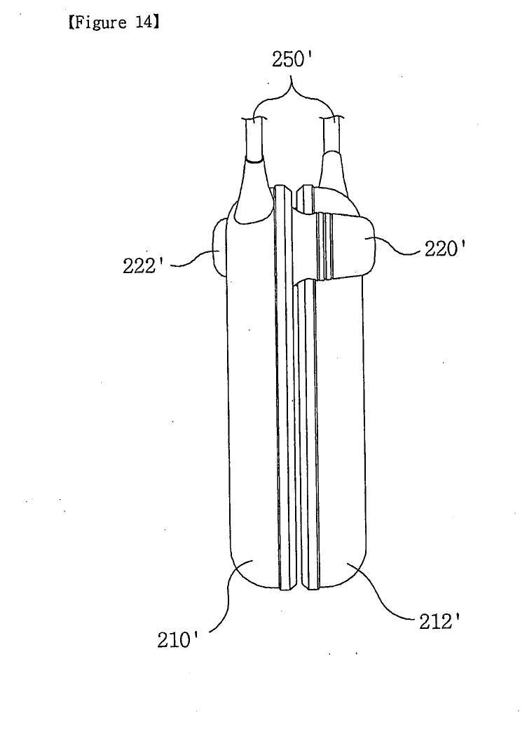

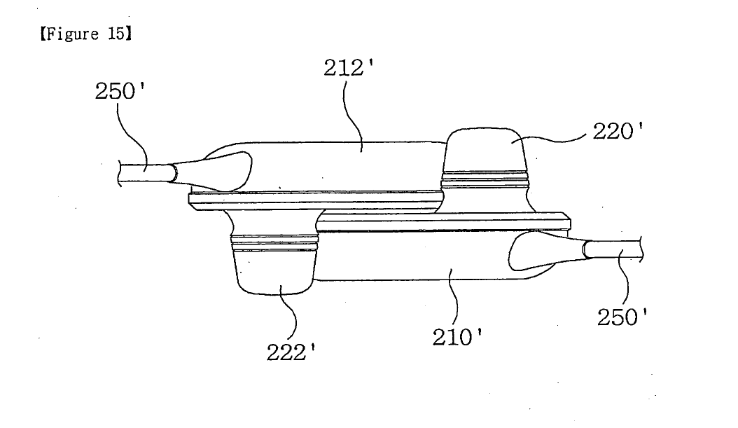

Referring to FIG. 11 through FIG. 15, in a headset 200′, respective first sides of casings 210′ and 212′ to which speaker housings 220′ and 222′ are installed are provided with respective permanent magnets 230′ and 232′, and the speaker housings 220′ and 222′ are eccentrically installed and arranged on the first sides of the casings 210′ and 212′, so that the speaker housings 220′ and 222′ do not protrude from the outer surfaces of the casings 210′ and 212′.

### THIRD EMBODIMENT

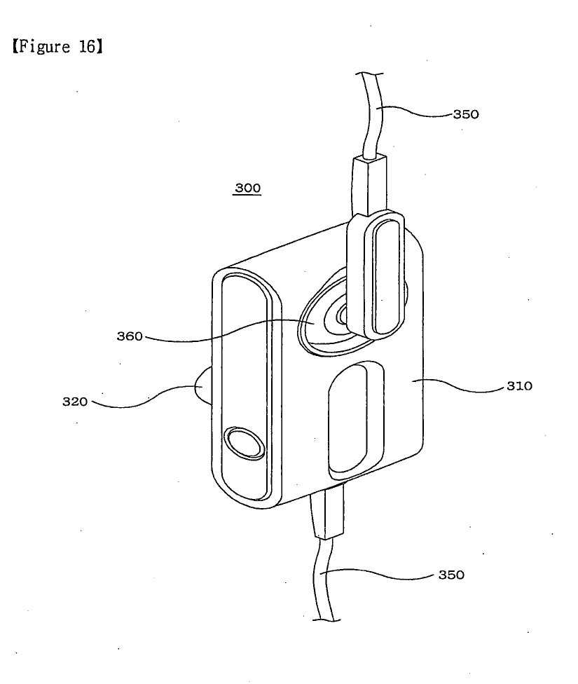

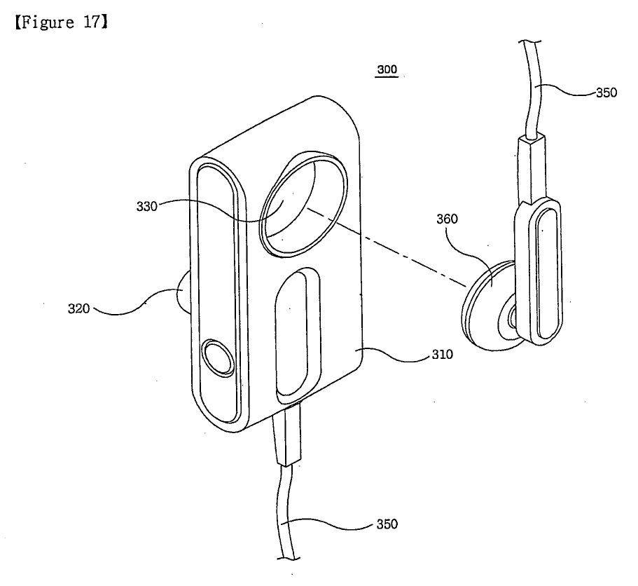

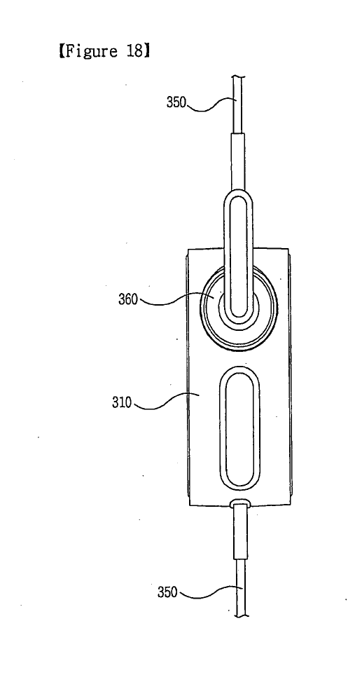

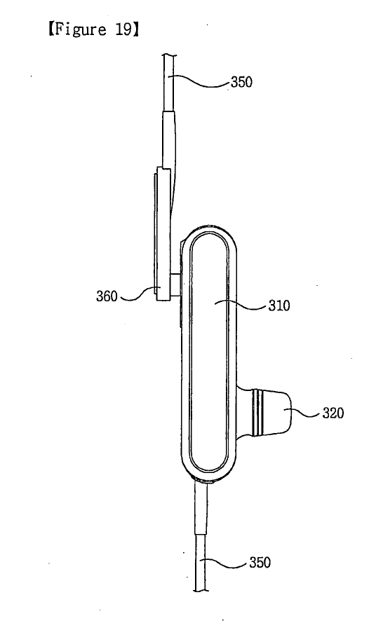

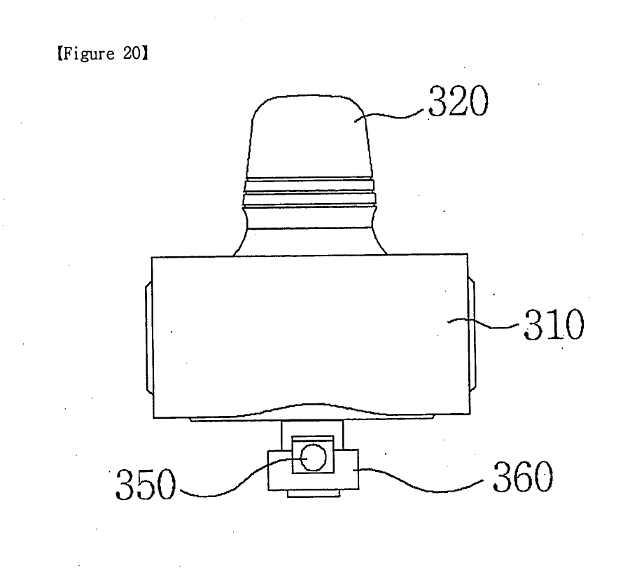

Referring to FIG. 16 through FIG. 20, a headset 300 according to a third embodiment of the present invention comprises a casing 310 employing a Bluetooth module (not shown) or a battery pack (not shown) therein, a speaker housing 320 encasing a speaker (not shown) therein and installed to a first side of the casing 310 to protrude from the outer surface of the first side of the casing 310, and an earphone casing 360 connected to the casing 310 via a cable 350 enclosing wires therein and having a speaker therein.

The casing 310 further has a depression 330 on the outer surface of a second side of the casing 310, on which the speaker housing 320 is not provided, and the earphone casing 360 is received in the depression 330 by being pressed. Since the earphone casing 360 is installed into the depression 330, the cable 350 forms a ring shape, so that the headset 300 can be worn around a user's neck.

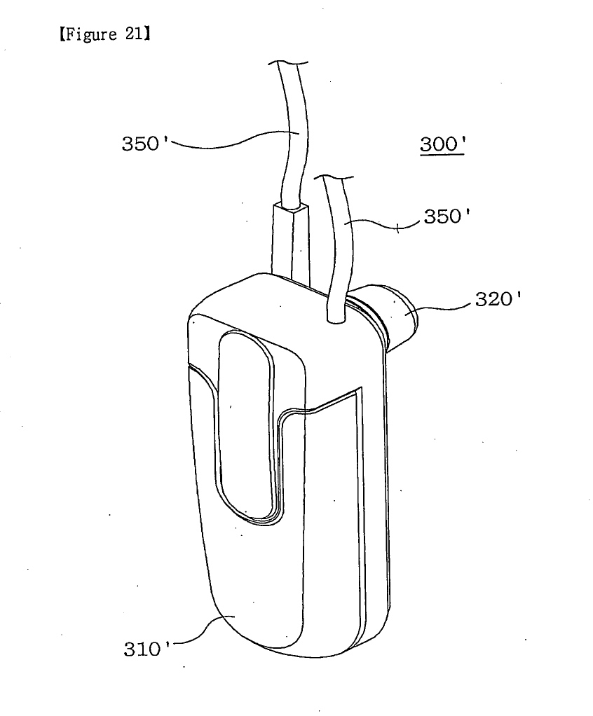

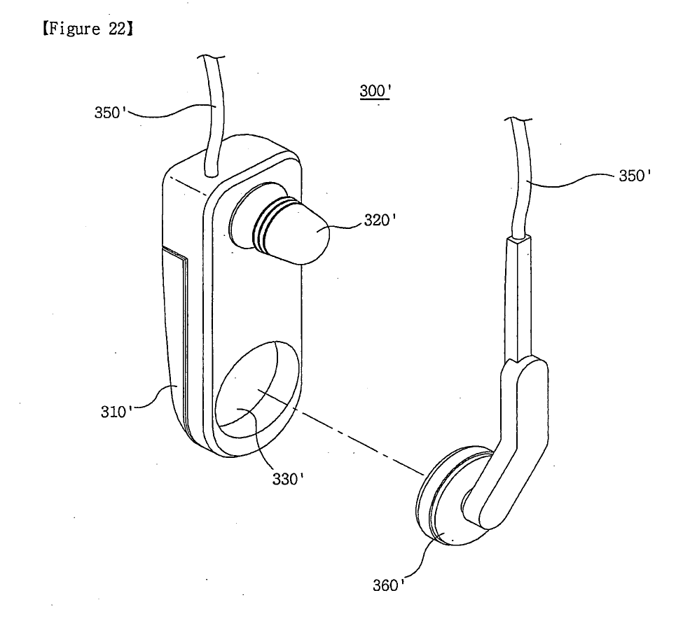

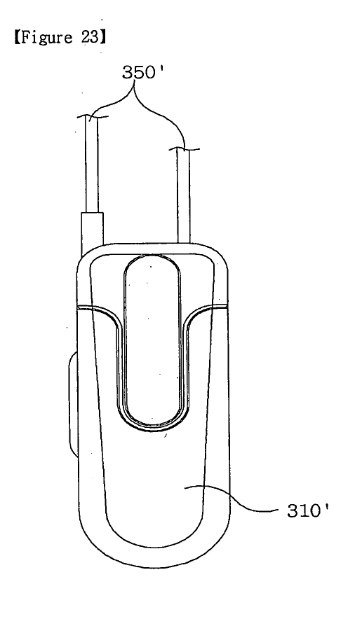

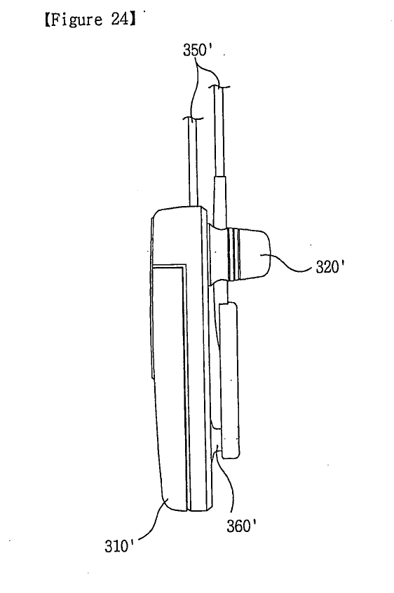

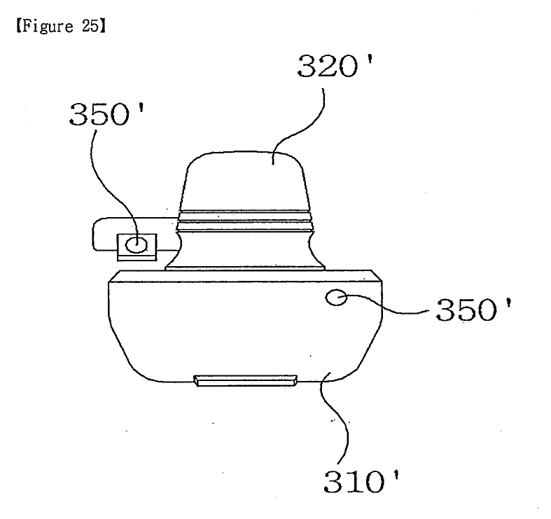

On the other hand, referring to FIG. 21 through FIG. 25, a casing 310′ has a depression 330′ for receiving an earphone casing 360′ on a surface thereof, on which a speaker housing 320′ is provided, so that the speaker housing 320′ is not exposed outside of the casing.

### FOURTH EMBODIMENT

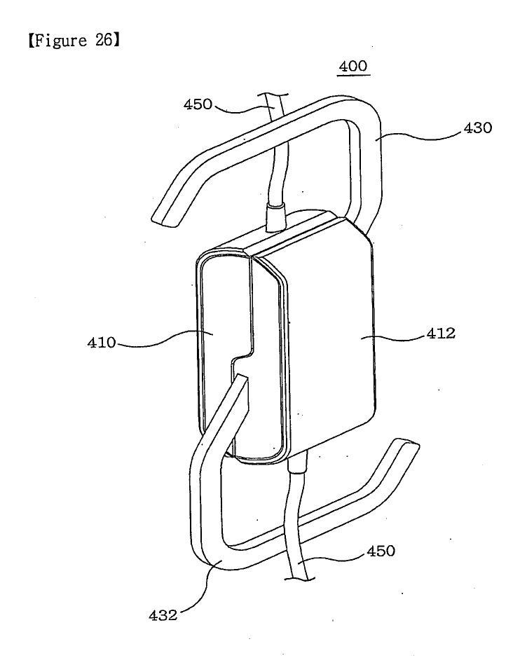

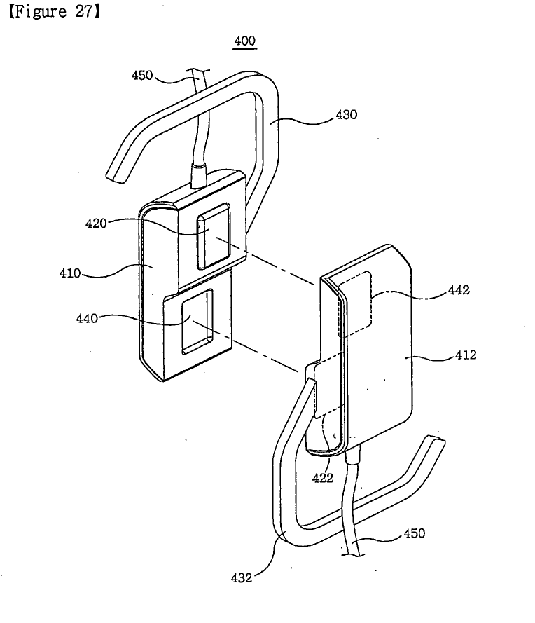

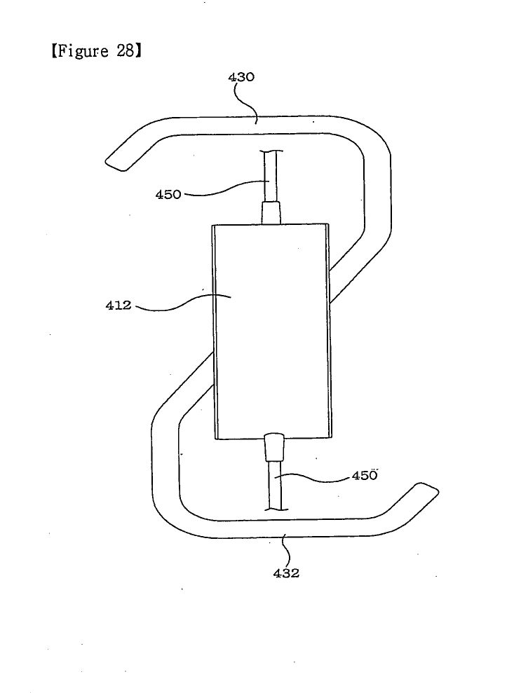

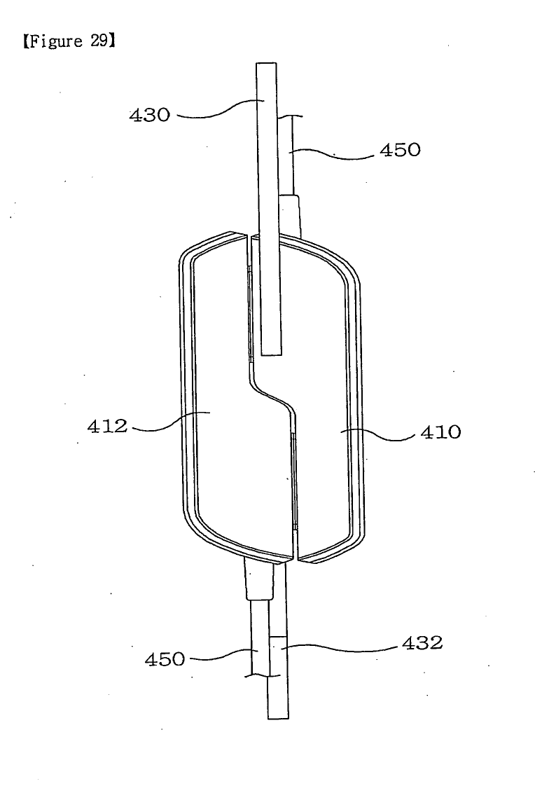

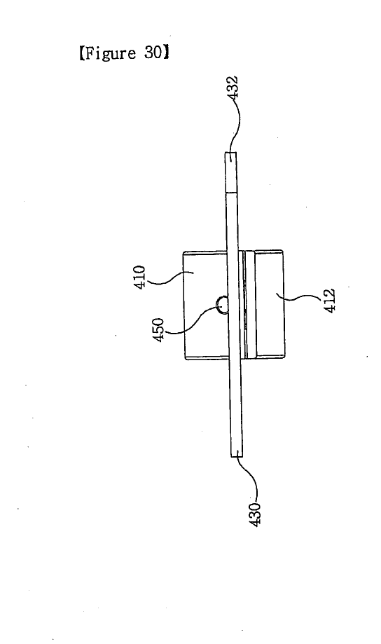

Referring to FIG. 26 through FIG. 30, a headset 400 according to a fourth embodiment of the present invention comprises a pair of casings 410 and 412 having structures corresponding to each other, in which a Bluetooth module (not shown) is enclosed in at least one casing of the casings 410 and 412 and speakers (not shown) are installed in the casings 410 and 412. The casings 410 and 412 have respective speakers covers 420 and 422 in which the speakers (not shown) are received installed on the outer surfaces of respective first surfaces thereof. The casings 410 and 412 have respective ear loops 430 and 432 that can be worn around respective outer ears of a user on respective side surfaces thereof. The casings 410 and 412 are connected via a cable 450 enclosing wires therein.

The speaker has an electromagnet and a permanent magnet therein. A user can listen to sound through the speaker since a vibration plate is vibrated by attractive pulses and repulsive pulses exerted between the electromagnet and the permanent magnet when current is applied to the electromagnet. Accordingly, this embodiment is provided to be attached to and detached from itself using permanent magnets embedded in all general earphones. That is, iron pieces that can be attached to the permanent magnets in speakers by magnetic force are provided inside the casings 410 and 412 or are installed on the outer surfaces of the casings 410 and 412.

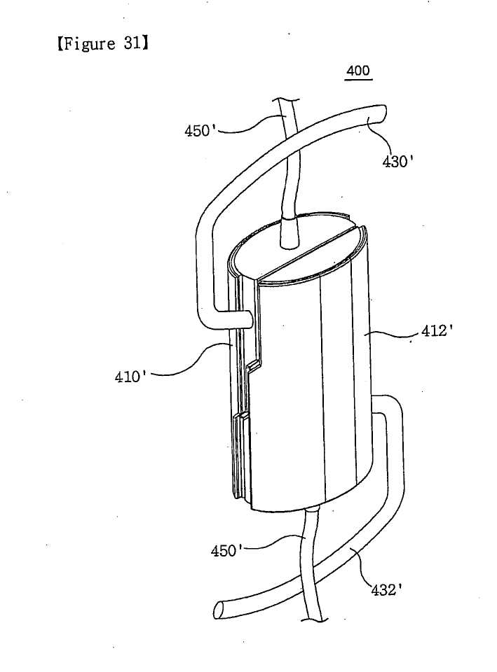

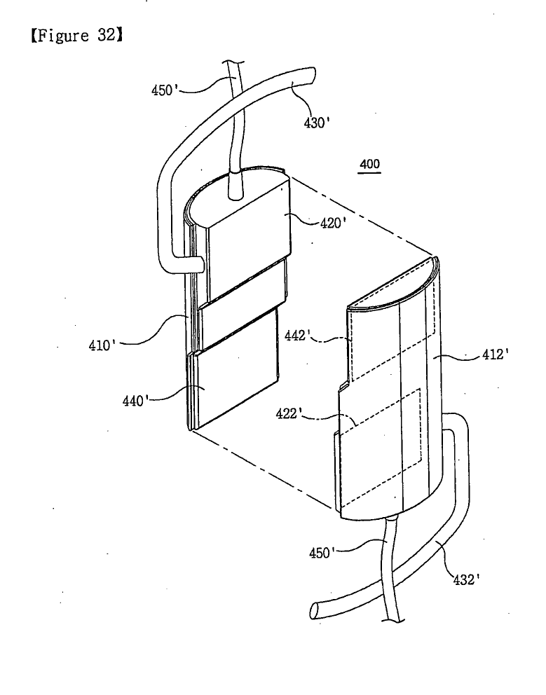

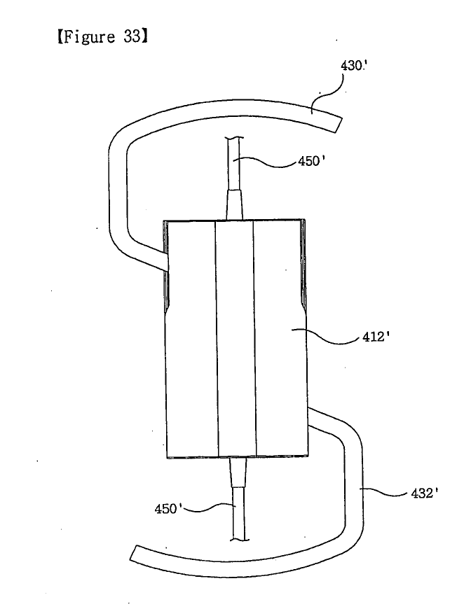

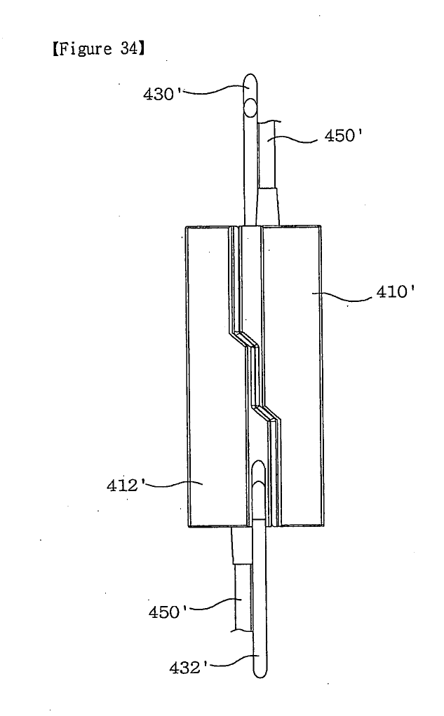

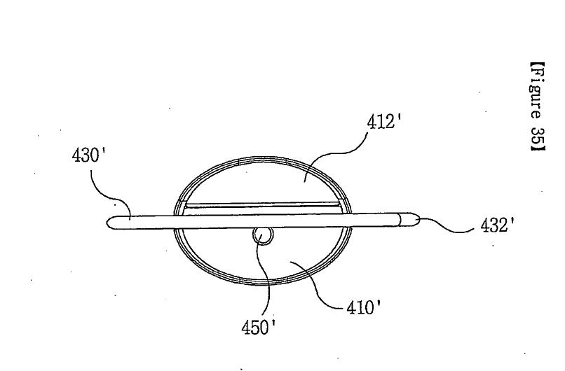

Referring to FIG. 26 through FIG. 30, the casings 410 and 412 have respective receiving parts 440 and 442 for safely receiving iron pieces thereon and the speaker covers 420 and 422 therein on respective second sides of thereof. Further, referring to FIG. 31 through FIG. 35, a step may be formed between the speaker covers 420′ and 422′, and the respective receiving parts 440′ and 442′, so that they correspond to each other. The headset 400 according to the fourth embodiment of the present invention does not have a permanent magnet, as does the headset 200 according to the second embodiment does.

### FIFTH EMBODIMENT

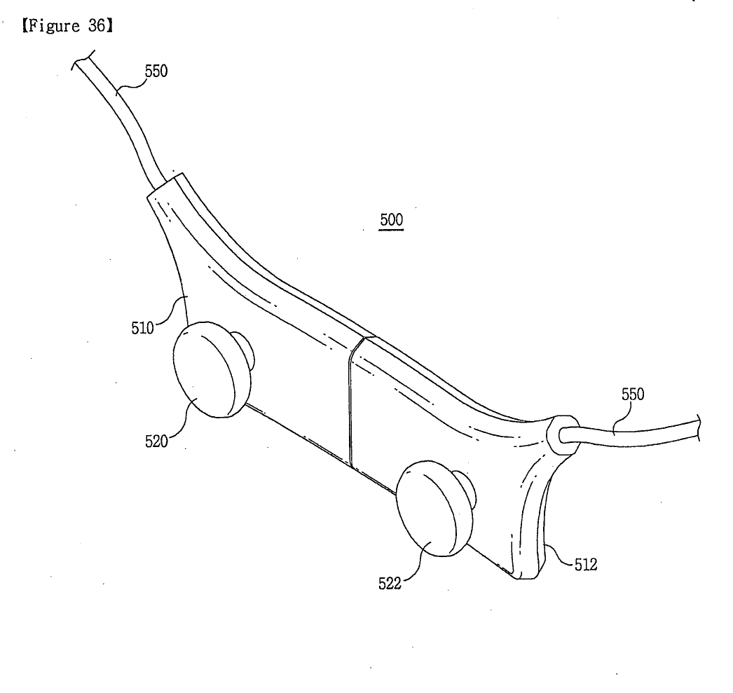

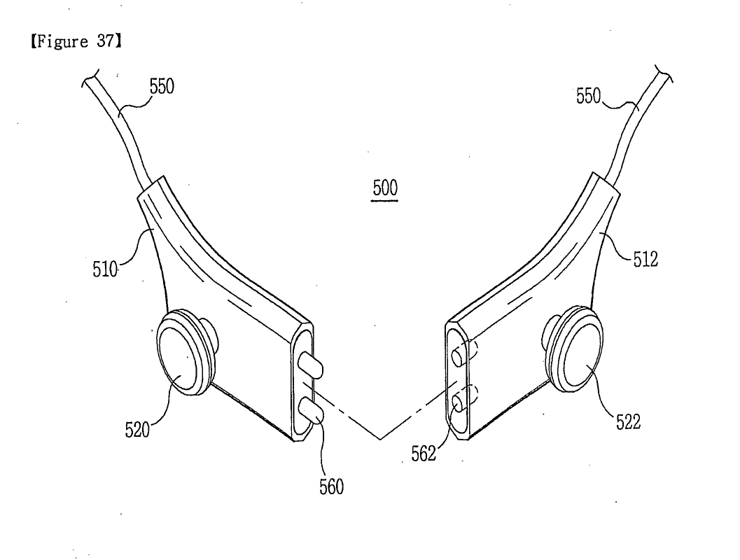

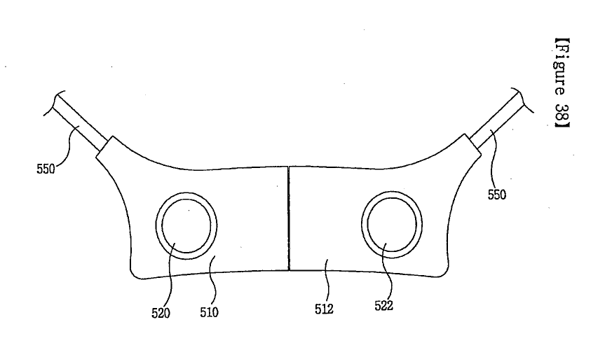

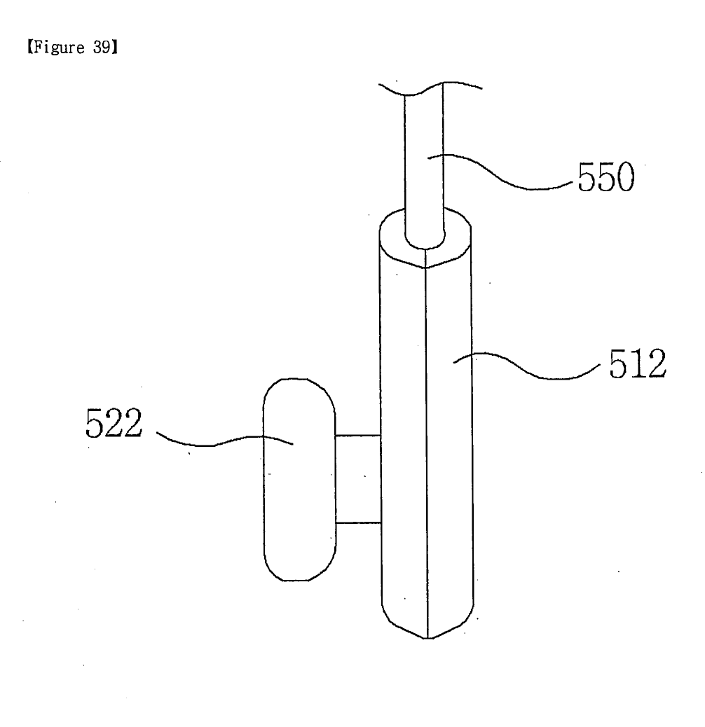

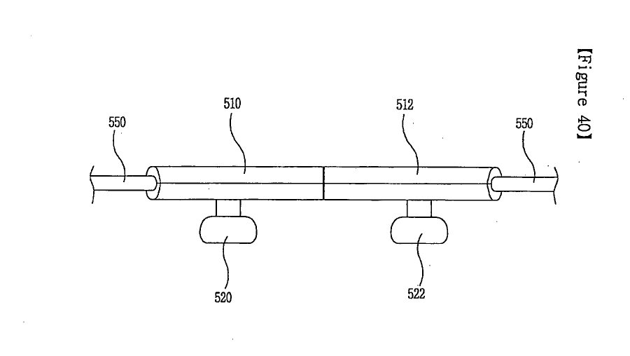

Referring to FIG. 36 through FIG. 40, a headset 500 according to a fifth embodiment of the present invention comprises a pair of casings 510 and 512 structured to correspond to each other and symmetrically arranged in left and right sides thereof, a Bluetooth module (not shown) is enclosed in at least one casing of the casings 410 and 412, and speaker housings 520 and 522 having respective speakers therein for being inserted into ears and installed in the casings 510 and 512 to protrude from outer surfaces of respective first sides of the casings 510 and 512. The casings 510 and 512 are connected via a cable 550.

One casing 510 of the casings 510 and 512 has a coupling projection 560 on the surface of a first side thereof, and the other casing 512 of the casings 510 and 512 has a coupling depression 562 on the surface of a first side thereof, so that the coupling projection 560 is forcedly inserted into the coupling depression 562 and temporarily fixed in the coupling depression 562.

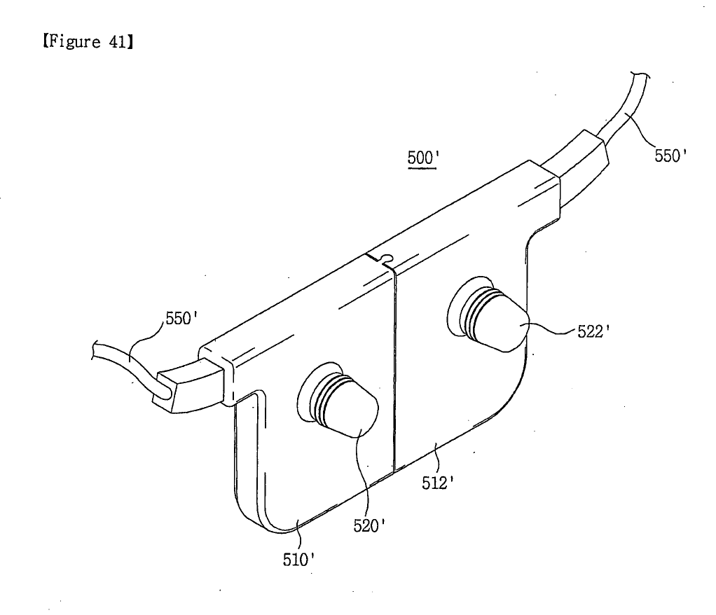

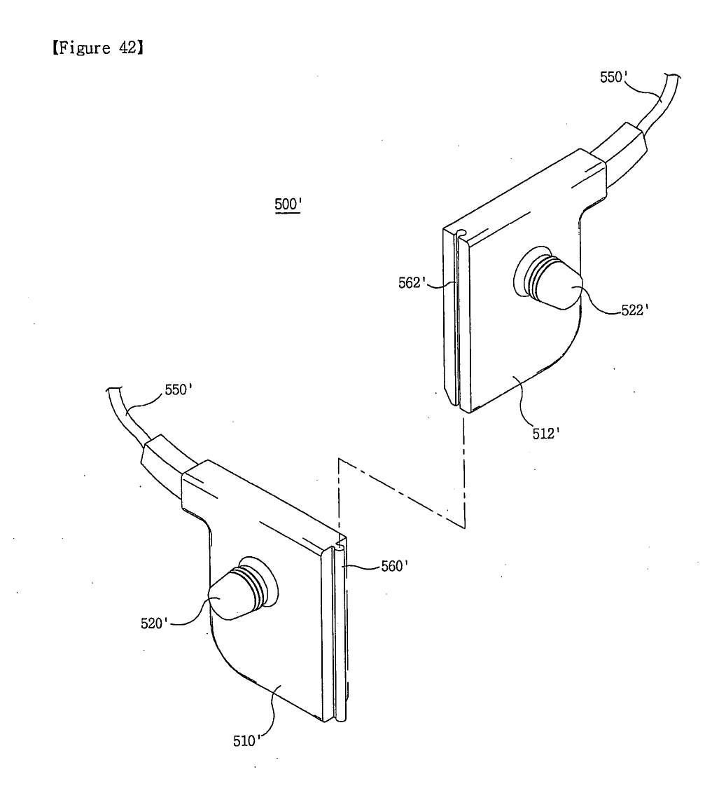

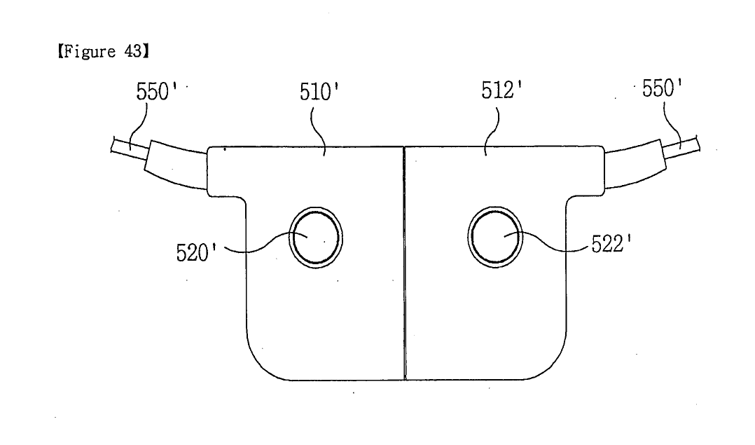

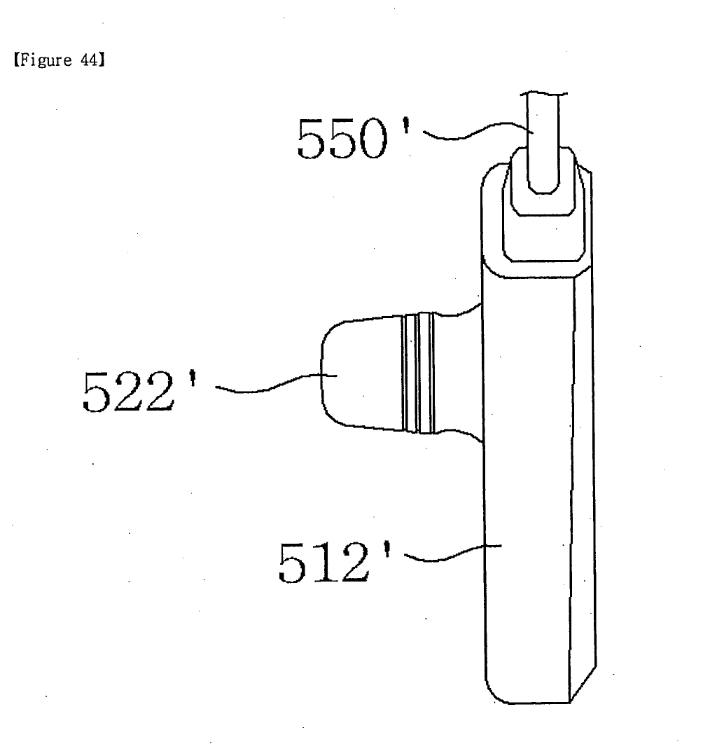

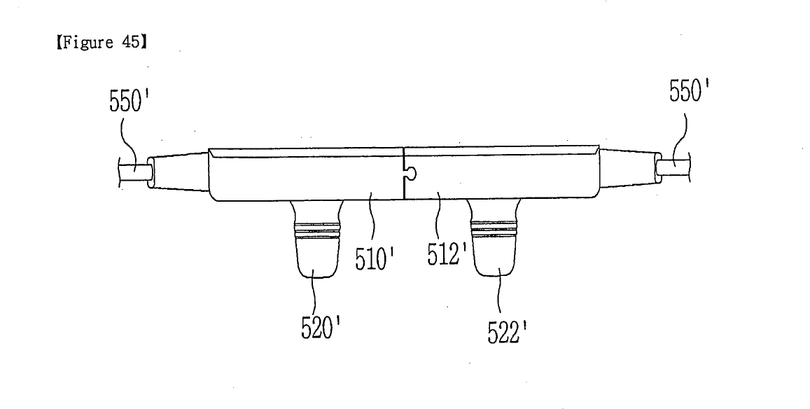

Referring to FIG. 41 through FIG. 45, a first side of one casing 510′ has a sliding projection 560′, and a first side of the other casing 512′ has a sliding depression 562′ so that the sliding projection 560′ is inserted into the sliding depression 562′. The sliding projection 560′ slides into the sliding depression 562′ so that the sliding projection 560′ is temporarily fixed into the sliding depression 562′.

As described above, a Bluetooth module embedded radio earphone having a “V” shape does not have a problem while it is used and inserted user's ears, but it is difficult to store and carry when it is not used. In order to solve the problem above, the headset according to the present invention includes a pair of casings connected via a cable and provided with at least one Bluetooth module and respective speakers therein, in which respective sides of the casings have respective depressions for receiving the speaker housings to be inserted into user's ears, the speaker housings are inserted into the depressions by being forcedly pressed, and the casings are detachably attached to each other. Accordingly, it is readily understood that a variety of variations and modifications of the headset according to the present invention can be made within the scope of the present invention by people skilled in the art.

1. A necklace type radio headset for stereo listening, having a pair of casings enclosing one or more Bluetooth modules therein which receive electric signals transmitted from an external electronic device, and enclosing respective speakers therein, the casings connected to each other via a cable,
wherein speaker housings which are provided to be inserted into respective ears of a user and enclose respective speakers therein are installed to respective first sides of the casings, whereby protruding from outer surfaces of the first sides of the casings, and wherein speaker housing receiving depressions are formed on respective casings to which the speaker housings are provided, so that the respective speaker housings are received in the depressions, respectively, by being pressed.

2. A necklace type radio headset for stereo listening, having a pair of casings enclosing respective speakers therein and enclosing one or more Bluetooth modules which receive electric signals transmitted from an external electronic device, the casing connected to each other via a cable,
wherein speaker housings which are provided to be inserted into respective ears of a user and enclose the speakers are installed to outer surfaces of respective sides of the casings to protrude from the outer surfaces of the casings, and wherein permanent magnets having different poles are installed inside respective casings on respective second sides of the casings, the second sides not having the speaker housings thereon, so that the casings are attached to each other and detached from each other by magnetic force exerted between the permanent magnets.

3. The necklace type radio headset according to claim 2, wherein the permanent magnets are installed outside the casings.

4. A necklace type radio headset for stereo listening, having a pair of casings enclosing respective speakers therein and enclosing one or more Bluetooth modules for receiving electric signals transmitted from an external electronic device, the casings connected to each other via a cable,
wherein speaker housings which are provided to be inserted into respective ears of a user and enclose respective speakers are installed outside the casings to protrude from outer surfaces of respective first sides of respective casings, and wherein a permanent magnet is provided on a second side of the casing, the second side not having the speaker housings thereon, and an iron piece is provided on the other casing, so that the casings are attached to each other and detached from each other by magnetic force between the permanent magnet and the iron piece.

5. A necklace type radio headset for stereo listening, having a pair of casings enclosing respective speakers therein and enclosing one or more Bluetooth modules for receiving electric signals transmitted from an external electronic device, the casings connected to each other via a cable,
wherein speaker housings which are provided to be inserted into respective ear holes of a user and enclose respective speakers are installed on the casings, to protrude from outer surfaces of respective first sides of respective casings, and wherein permanent magnets are provided on respective first sides of the casings, the first sides having respective speaker housings installed thereon, in which the speaker housings are arranged on the casings in an eccentric manner.

6. A necklace type radio headset, having a casing in which a speaker outputting audible sound and a Bluetooth module receiving electrical signals transmitted from an external electronic device are enclosed therein,
wherein the casing is provided with a speaker housing enclosing the speaker;
an earphone casing having a speaker therein is connected to the casing via a cable;
a depression for receiving the earphone casing therein is formed on a side of the casing opposite the side having the speaker housing; and
the earphone casing is inserted into the depression by being pressed.

7. The necklace type radio headset according to claim 6, wherein the depression is provided on a surface of the casing, on which the speaker housing is provided.

8. A necklace type radio headset for stereo listening, having a pair of casings connected to each other via a cable, enclosing one or more Bluetooth modules for receiving electric signals transmitted from an external electronic device, and enclosing respective speakers therein,
wherein speaker covers encasing respective speakers are installed on outer surfaces of respective first sides of the casings;
ear loops are provided on respective second sides of the casings so as to be worn around respective outer ears of a user; and
iron pieces are provided on outer surfaces of the casings, the iron pieces attracting permanent magnets in the speakers.

9. The necklace type radio headset according to claim 8, wherein respective casings have respective receiving parts on respective second sides of the casings, which are outer sides of the casings, for receiving the speaker covers thereon and enclosing iron pieces therein.

10. The necklace type radio headset according to claim 9, wherein respective steps exist between respective speaker covers and respective receiving parts.

11. A necklace type radio headset or stereo listening, having a pair of casings enclosing one or more Bluetooth modules therein which receive electrical signals transmitted from an external electronic device, and enclosing respective speakers therein, the casings being connected via a cable,
wherein the casing as a coupling projection at a side thereof, and the other casing has a coupling depression having a shape corresponding to that of the coupling projection, so that the coupling projection is forcedly inserted into the coupling depression by external pressure.

12. The necklace type radio headset according to claim 11, wherein speaker housings enclosing the speakers respectively, provided to be inserted into ears of a user, and installed to protrude from outer surfaces of respective outward sides of the casings, wherein the coupling projection and the coupling depression are formed on surfaces of respective sides of the casings.

13. A necklace type radio headset for stereo listening, having a pair of casings enclosing one or more Bluetooth modules which receive electrical signals transmitted from an external electronic device, and enclosing respective speakers therein, the casings being connected via a cable,
wherein the casing has a sliding projection at a side thereof, and the other casing has a sliding depression having a shape corresponding to that of the sliding projection, so that the sliding projection slides into the sliding depression and the sliding projection is selectively fixed.

14. The necklace type radio headset according to claim 1, claim 2, claim 4, claim 5, claim 6, claim 8, claim 11 or claim 13, wherein the electronic device is a mobile wireless phone which converts high frequency signals received via an antenna into radio frequency data and transmits the data to a Bluetooth module of the headset.

15. The necklace type radio headset according to claim 1, claim 2, claim 4, claim 5, claim 6, claim 8, claim 11 or claim 13, wherein at least one of the casings encloses a microphone therein.
